(19) United States
(12) Patent Application Publication
(10) Pub. No.: US 2020/0339881 A1
(43) Pub. Date: Oct. 29, 2020

(54) USE OF A HYDRAULIC BINDER COMPOSITION IN A METHOD FOR INERTING POLLUTED SOIL

(71) Applicant: VICAT, Paris La Defense (FR)

(72) Inventors: Yvan-Pierre JACOB, Pont de Beauvoisin (FR); Laury BARNES-DAVIN, Voiron (FR); Virginie NOWALSKI, Chassignieu (FR)

(73) Assignee: VICAT, Paris La Defense (FR)

(21) Appl. No.: 16/962,094

(22) PCT Filed: Feb. 19, 2019
(86) PCT No.: PCT/FR2019/050367

§ 371 Date: Jul. 14, 2020

(30) Foreign Application Priority Data
Feb. 20, 2018 (FR) 18/51436

(51) Int. Cl. C09K 17/10; B09C 1/08; C04B 28/06; C04B 22/06; C04B 22/14

(52) U.S. Cl. CPC C09K 17/10; B09C 1/08; C04B 2111/00732; C04B 22/064; C04B 22/14; C04B 28/065

(57) ABSTRACT

A method for inerting polluted soil, comprising adding to a polluted soil a composition comprising: from 40% to 99% of a sulfoaluminous clinker comprising as a phase composition, to the overall weight of the clinker: from 5% to 80% of a calcium sulfoaluminate phase possibly iron-doped corresponding to the formula C4AxFy$z in which x varies from 2 to 3; y varies from 0 to 0.5; and z varies from 0.8 to 1.2; from 0 to 25% of a calcium aluminoferrite phase of a composition corresponding to the general formula C₆A_{x′}F_{y′}; x′ varies from 0 to 1.5; and y′ varies from 0.5 to 3; and from 10% to 70% of a belite phase C₂S; and from 1% to 60% of a lime.

An object of the present invention is the use of a composition comprising a hydraulic binder and lime in a method for inerting a polluted soil as well as some of the used compositions.

The pollution of soils is a topical issue mobilizing more and more resources in particular because of its direct impact on the environment and, consequently, on humans, animals and plants health.

A soil is considered to be polluted when it contains one or several pollutant(s) or contaminant(s) likely to cause biological, physical and chemical alterations. A pollutant is defined as a biological, physical or chemical environmentally-hazardous agent, which, beyond a determined threshold, and sometimes under some conditions, results in negative impacts on all or part of an ecosystem or the environment in general. In other words, the introduction of toxic, possibly radioactive, substances, or of pathogen organisms cause a substantial disturbance of the ecosystem. Amongst the pollutants that are often found in soils, mention may be made in particular to organic matters, hydrocarbons such as polycyclic aromatic hydrocarbons (PAH), polychlorinated biphenyl (PCB), sulfates, chlorides, fluorides and heavy metals.

In turn, a polluted soil becomes a possible source of direct or indirect diffusion of pollutants in the environment, in particular via water, the gaseous emissions or via a re-concentration and a transfer of pollutants through living organisms such as bacteria, fungi or plants when these are, in turn, eaten by animals. Once in the food chain, the pollutants come into contact with humans through feeding. Depending on the pollutant and the context, the impacts of soil contamination may be direct or indirect, immediate or deferred.

Hence, soils decontamination constitutes a major concern for environment and health. Moreover, even though it does not represent an immediate hazard to health, it could turn out to be necessary to decontaminate a site in order to protect the ecosystems or to enhance its value (into a building area for example) by reducing the risk to which the future users might be exposed.

There are several major methods for soil decontamination. Some of them allow extracting all or part of the pollutants contained in the soil, other allow destroying them (when these consist of degradable pollutants). These decontamination methods may be carried out off-site, on-site or in-situ. In general, the two first ones require the excavation of the ground to be treated, the last one is performed locally by implementing the decontamination method on-site.

Other methods, allowing reducing the hazardousness of a polluted soil, may also be used. This is in particular the case of so-called «inerting» methods aiming at reducing, and even suppressing, the action of a contaminant on the environment by preventing its chemical or biochemical reactivity and/or its dispersal into the environment. For this purpose, it is desired to transform the pollutant into a matter deprived of any activity or proper motion, and therefore impart a definitive or long-term chemical inertia thereto. Hence, this technique enables a «stabilization» of the treated ground and the reclassification thereof.

The commonly implemented inerting methods are the methods for stabilization/solidification by hydraulic binders. The stabilization technique is a process in which the pollutant is converted into a form that is chemically more stable, whereas the solidification method captures the heavy metals into a solid structure. The results in the conventional leaching tests (in particular according to the standards NF EN 12457-1, 12457-2, 12457-3 and 12457-4 of 2002) demonstrate the effectiveness of these techniques.

Indeed, the addition of the hydraulic binder allows obtaining stabilization of the soil (chemical reduction of the hazardous capability by conversion of the contaminants into a less soluble, mobile or toxic form) and solidification (encapsulation of the waste by forming a solid material). The migration of the contaminants is reduced by the reduction of the surface that is exposed to leaching and/or by sealing the treated material.

The most used hydraulic binders in the process of inerting a polluted soil are Portland cement and slag cement. The hydration of these cements in the presence of a pollutant enables not only a capture of the pollutant into the structure of the cement by physically reducing the mobility thereof and therefore the possible leaching thereof, but also the formation, during the hydration of the cement, of a combination of the pollutant in the crystalline structure of the hydrates.

The use of sulfoaluminous clinkers is also known and has a particular interest because of the formation, during the hydration thereof, of large amounts of ettringite, which is a mineral species composed by calcium sulfate and hydrated aluminum, with a chemical formula Ca₆Al₂(SO₄)₃(OH)₁₂.26H₂O. Ettringite is a product of the reaction between tricalcium aluminate C₃A, sulfate, $ and water. Ettringite enables numerous ionic substitutions in its structure yet without modifying the stability thereof. Hence, it is capable of capturing and inerting the main heavy metals in a cationic form into its structure. Furthermore, for its formation, ettringite requires calcium sulfate. Hence, by its mere formation, it also allows reducing the sulfate ions content of the soil.

However, the use of hydraulic binders such as sulfoaluminous clinkers in the inerting process may lead to a release of chromium in the Cr⁶⁺ form in the treated soil. Yet, this hexavalent chromium is toxic.

Hence, this chromium release limits the interest of the use of sulfoaluminous clinkers in inerting methods. However, it would be interesting to identify a composition having the same properties as sulfoaluminous clinkers in polluted soil inerting, but which do not release (or releases less) chromium during the use thereof.

Yet, quite surprisingly, it has now been found that the addition of lime to a sulfoaluminous clinker allows significantly limiting the release of chromium during the use of said clinker in the process of inerting a polluted soil, yet without reducing the effectiveness thereof.

Thus, an object of the present invention is the use of a composition comprising:
from 40% to 99% of a sulfoaluminous clinker comprising as a phase composition, with respect to the overall weight of the clinker:
from 5% to 80% of a calcium sulfoaluminate phase possibly iron-doped corresponding to the formula C4AxFy$z in which
x varies from 2 to 3;
y varies from 0 to 0.5; and
and z varies from 0.8 to 1.2;
from 0 to 25% of a calcium aluminoferrite phase of a composition corresponding to the general formula C₆A_{x′}F_{y′}
x′ varies from 0 to 1.5; and
y′ varies from 0.5 to 3; and
from 10% to 70% of a belite phase C₂S;
and from 1% to 60% of a lime;

in a method for inerting a polluted soil.

The admixture of lime to the sulfoaluminous clinker allows limiting the chromium release significantly during the use of the latter in a method for inerting a polluted soil, yet without reducing the effectiveness thereof.

In the context of the present invention:
by «method for inerting a polluted soil», it should be understood any method allowing reclassifying a polluted ground comprising a stabilization of the soil by conversion of the contaminants into a form that is less soluble, mobile or toxic and, possibly, an encapsulation of the waste by forming a solid material; and
by «polluted soil» or «soil contamination», it should be understood any form of pollution, whether chemical, industrial or other, affecting any type of soil, whether the latter is agricultural, forested, urban or other;
by «lime», it should be understood quicklime or slaked lime;
by «quicklime», it should be understood any product of calcination of limestone having variable calcium and magnesium carbonates contents and containing impurities such as clays, in particular calcium oxide (CaO);
by «slaked lime», it should be understood any type of calcium hydroxide originating from the hydration of quicklime, in particular calcium hydroxide Ca(OH)₂.

In the context of the present invention, the following notations are adopted to refer to the mineralogical components of the cement:
C represents CaO;
A represents Al₂O₃;
F represents Fe₂O₃;
S represents SiO₂; and
$ represents SO₃.

Thus, for example, the calcium aluminoferrite phase of a composition corresponding to the general formula C₆A_{x′}F_{y′} actually corresponds to a phase (CaO)₆(Al₂O₃)_{x′}(Fe₂O₃)_{y′}.

In addition, in the context of the present invention, the proportions expressed in % correspond to mass percentages with respect to the overall weight of the considered entity (clinker or hydraulic binder).

Hence, an object of the present invention is the use of a composition comprising a sulfoaluminous clinker and lime in a method for inerting a polluted soil. Preferably, an object of the present invention is the use, in a method for inerting a polluted soil, of a composition as previously described wherein the following features are selected separately or in combination:
the clinker contains from 5% to 60% of a calcium sulfoaluminate phase possibly iron-doped C₄AₓF_{y}$_{z}, preferably from 10% to 60% of a calcium sulfoaluminate phase C₄AₓF_{y}$_{z};
x varies from 2.1 to 2.9, preferably from 2.2. to 2.8;
y varies from 0.05 to 0.5, preferably from 0.1 to 0.5;

the calcium sulfoaluminate phase contains alumina, iron and sulfur with x varying from 2.1 to 2.9, preferably from 2.2 to 2.8, y varying from 0.05 to 0.5, preferably from 0.1 to 0.5, and z varying from 0.8 to 1.2;
the clinker contains from 0 to 20% of a calcium aluminoferrite phase C₆A_{x′}F_{y′};
the calcium aluminoferrite phase C₆A_{x′}F_{y′} contains alumina and iron with x′ varying from 0.65 to 1.3 and y′ varying from 1.5 to 2.5;
the clinker contains from 5% to 80% of a belite phase C₂S, preferably from 30% to 55% of a belite phase C₂S;
the composition contains from 70% to 99% of a sulfoaluminous clinker as previously described, preferably from 70% to 98% of a sulfoaluminous clinker as previously described, even more preferably from 75% to 95% of a sulfoaluminous clinker as previously described; and/or
the composition further contains a set retarder in order to slow down the hydration of the clinker and therefore the formation of ettringite, or a set accelerator in order to accelerate the hydration of the clinker and the formation of ettringite. Preferably, the set retarder is selected from boric acid, citric acid or tartaric acid, and the set accelerator is selected from lithium carbonate or sodium carbonate.

Hence, the composition used in the context of the present invention may contain quicklime or slaked lime.

Hence, an object of the present invention is the use, in a method for inerting a polluted soil, of a composition as previously described comprising from 1% to 60% of quicklime, preferably from 1% to 30% of quicklime, even more preferably from 2% to 30% of quicklime, quite preferably from 5% to 25% of quicklime.

Another object of the present invention is the use, in a method for inerting a polluted soil, of a composition as previously described comprising from 1% to 60% of slaked lime, preferably from 1% to 30% of slaked lime, even more preferably from 2% to 30% of slaked lime, quite preferably from 5% to 25% of slaked lime.

Finally, other minor phases may be present in the sulfoaluminous clinker used in the context of the present invention. These minor phases may be constituted by quicklime CaOI, anhydrite C$, gehlenite C₂AS, mayenite C₁₂A₇, periclase MgO, perovskite CT, C₃FT, C₄FT₂. Preferably, the clinker according to the invention contains:
less than 3% of CaOI, preferably less than 1% of CaOI;
less than 5% of C$, preferably less than 2% of C$; and/or
less than 10% of C₂AS, preferably less than 5% of C₂AS.

The composition according to the present invention may be used in any method for inerting a polluted soil known to those skilled in the art. As example, mention may in particular be made to the following method for inerting a polluted soil:
spreading of the binder over the soil to be treated,
blending of the soil and the binder,
sprinkling of the mixture with water, and
compaction of the treated soil.

Some compositions used in the context of the present invention are new. Thus, another object of the present invention is a composition for inerting a polluted soil comprising:
from 70% to 98% of a sulfoaluminous clinker comprising as a phase composition, with respect to the overall weight of the clinker:
from 5% to 60% of a calcium sulfoaluminate phase possibly iron-doped corresponding to the formula C4AxFy$z in which
x varies from 2 to 3;
y varies from 0 to 0.5; and
and z varies from 0.8 to 1.2;
from 0 to 25% of a calcium aluminoferrite phase of a composition corresponding to the general formula C₆A_{x′}F_{y′}
x′ varies from 0 to 1.5; and
y′ varies from 0.5 to 3; and
from 20% to 70% of a belite phase C₂S;
and from 2% to 30% of a lime.

Preferably, another object of the present invention is a composition for inerting a polluted soil, as previously described wherein the following features are selected separately or in combination:
the clinker contains from 10% to 50% of a calcium sulfoaluminate phase possibly iron-doped C₄AₓF_{y}$_{z};
x varies from 2.1 to 2.9, preferably from 2.2. to 2.8;
y varies from 0.05 to 0.5, preferably from 0.1 to 0.5;
the calcium sulfoaluminate phase contains alumina, iron and sulfur with x varying from 2.1 to 2.9, preferably from 2.2 to 2.8, y varying from 0.05 to 0.5, preferably from 0.1 to 0.5, and z varying from 0.8 to 1.2;
the clinker contains from 0 to 20% of a calcium aluminoferrite phase C₆A_{x′}F_{y′} with:
x′ varying from 0.65 to 1.3; and
y′ varying from 1.5 to 2.5;
the calcium aluminoferrite phase C₆A_{x′}F_{y′} contains alumina and iron with x′ varying from 0.65 to 1.3 and y′ varying from 1.5 to 2.5;
the clinker contains from 30 to 55% of a belite phase;
the composition contains from 70% to 97% of a sulfoaluminous clinker as previously described, even more preferably from 75% to 95% of a sulfoaluminous clinker as previously described;
the composition contains from 3% to 30% of lime, even more preferably from 5% to 25% of lime;
the lime contained in the composition is slaked lime; and/or
the composition further contains a set retarder in order to slow down the hydration of the clinker and therefore the formation of ettringite, or a set accelerator in order to accelerate the hydration of the clinker and the formation of ettringite. Preferably, the set retarder is selected from boric acid, citric acid or tartaric acid, and the set accelerator is selected from lithium carbonate or sodium carbonate.

Other minor phases may be present in the sulfoaluminous clinker used in the context of the present invention. These minor phases may be constituted by quicklime CaOI, anhydrite C$, gehlenite C₂AS, mayenite C₁₂A₇, periclase MgO, perovskite CT, C₃FT, C₄FT₂. Preferably, the clinker according to the invention contains:
less than 3% of CaOI, preferably less than 1% of CaOI;
less than 5% of C$, preferably less than 2% of C$; and/or
less than 10% of C₂AS, preferably less than 5% of C₂AS.

The clinker used in the composition according to the present invention may be prepared according to any method known to those skilled in the art.

The present invention may be illustrated without limitation by the following examples.

### EXAMPLE 1—SULFOALUMINOUS CLINKER USED IN THE CONTEXT OF THE PRESENT INVENTION

### Example 1.1—Alpenat

The clinker Alpenat® from the company Vicat has been used for the tests conducted in the context of the present invention. The chemical and mineralogical compositions of this clinker are reported respectively in the following Tables 1 and 2.

TABLE 1
□ ALPENAT □ Chemical composition

| Oxides | % (w/w) |
|---|---|
| SiO₂ | 10.55 |
| Al₂O₃ | 23.46 |
| CaO | 45.07 |
| MgO | 1.00 |
| Fe₂O₃ | 9.70 |
| TiO₂ | 1.29 |
| K₂O | 0.27 |
| Na₂O | 0.17 |
| P₂O₅ | 0.11 |
| Mn₂O₃ | 0.01 |
| SO₃ | 8.07 |
| SrO | 0.06 |
| Cl | 0.01 |
| Loss on ignition | 0.23 |

TABLE 2
□ ALPENAT □ Mineral phase

| Mineral phase | % (w/w) |
|---|---|
| C₄A₃$ | 54.3 |
| C₆AF₂ | 1.2 |
| C₂S_{β} | 20.8 |
| C₂S_{α′high} | 8.3 |
| C₃MS₂ | 4.5 |
| C$ | 0.4 |
| Quicklime | 0.2 |
| γ-Fe₂O₃ | 1.0 |
| C₃FT | 9.3 |

### Example 1.2—CHC011

The clinker CHC011 from the company Vicat has been used for the tests conducted in the context of the present invention. The chemical and mineralogical compositions of this clinker are reported respectively in the following Tables 3 and 4.

TABLE 3
□ Clinker CHC011 □ Chemical composition

| Oxides | % (w/w) |
|---|---|
| SiO₂ | 6.05 |
| Al₂O₃ | 68.40 |
| CaO | 30.65 |
| MgO | 0.17 |
| Fe₂O₃ | 0.09 |
| TiO₂ | 0.01 |
| K₂O | 0.05 |
| Na₂O | 0.19 |
| P₂O₅ | 0.12 |
| Mn₂O₃ | 0.01 |
| SO₃ | 11.11 |
| SrO | 0.39 |
| Cl | 0.01 |
| Loss on ignition | 1.96 |

TABLE 4
□ Clinker CHC011 □ Mineral phase

| Mineral phase | % (w/w) |
|---|---|
| C₄A₃$ | 76 |
| C2AS | 6.5 |
| C₂S_{β} | 12 |
| C₂S_{α′high} | 4 |
| C₃MS₂ | 0.5 |
| C$ | 0.8 |
| Quicklime | 0.2 |

### EXAMPLE 2—INERTING COMPOSITION ACCORDING TO THE INVENTION

Compositions comprising:
80% of the clinker Alpenat according to the Example 1.1 and 20% of slaked lime (laboratory product: calcium hydroxide for analysis, purity 96%)—composition 1;
75% of the clinker Alpenat according to the Example 1.1 and 25% of quicklime—composition 2;
75% of the clinker CHC011 according to the Example 1.2 and 25% of slaked lime (laboratory product: calcium hydroxide for analysis, purity 96%)—composition 3; and 75% of the clinker CHC011 according to the Example 1.2 and 25% of quicklime—composition 4;
have been prepared by mixing the two components in a mortar mixer for 60 seconds at a speed of 140 rpm.

### EXAMPLE 3—INERTING OF A POLLUTED SOIL

3.1—Polluted Soil

In the context of the conducted tests, silt (clayey sand) artificially sulfated so as to increase its sulfate content beyond the limit value of 1000 mg/kg of a dry matter set according to the decree in force (Decree of Dec. 12, 2014 relating to the conditions of admission of inert wastes in plants under headings 2515, 2516, 2517 and in plants for storing inert wastes under heading 2760 of the classified plants nomenclature, JORF No. 0289 of Dec. 14, 2014, page 21032, text No. 11) has been used.

For this purpose, silt has been mixed with 2% (w/w) of laboratory gypsum (mixing for 5 min at 140 rpm). The obtained composition is reported in the following Table 3.

TABLE 3
□ Composition of the soil (gypsum silt)

| Silt + 2% of Gypsum | Limit values | Average |
|---|---|---|
| DMR 105° C._Dry matter rate | — | 85.5 |
| HR 105° C._Humidity rate | | 16.9 |
| Eluate volume (m) | | 580 |
| Temperature (° C.) | | 20.3 |
| pH | | 8.1 |
| Conductivity (μS/cm) | | 1604 |

Measured element mg/kg of dry matter (DM)

| | | |
|---|---|---|
| As | 0.5 | <0.01 |
| Ba | 20 | 0.47 |
| Cd | 0.04 | <0.01 |
| Cr | 0.5 | <0.05 |
| Cu | 2 | <0.05 |
| Mo | 0.5 | <0.05 |
| Ni | 0.4 | <0.05 |
| Pb | 0.5 | <0.05 |
| Sb | 0.06 | <0.01 |
| Se | 0.1 | <0.01 |
| Zn | 4 | 1.99 |
| Chloride | 800 | 23.3 |
| Fluoride | 10 | 2.93 |
| Sulfate | 1000 | 12375 |
| Hg | 0.01 | <0.005 |
| Fraction soluble at 105° C. | 4000 | 16223 |

3.2—Inerting Method

The gypsum silt is dry-mixed with one of the compositions 1 to 4 in a mortar mixer in accordance with the standard EN 196-3 (mixture for 60s at 140 rpm). Afterwards, the (ultrapure) water is added with a water-to-binder ratio equal to 1. Afterwards, mixing is continued for 120s at 140 rpm and then for 120s at 285 rpm.

The sample thus prepared is stored in a closed plastic bag for the desired maturation time.

In order to monitor the amount of water in the mixture, a fraction of the sample is crushed so as to be all passing at 4 mm, and then dried at 105° C.

3.3—Experimental Protocol

3.3.1□Standard NF-EN-12457-2 (December 2002)

The leaching tests have been carried out according to the protocol described in the standard NF EN 12457-2, namely:
reduction of the grain-size distribution of the sample (95% of the particles must be smaller than 4 mm),
determination of the dry matter rate and of the humidity rate,
leaching test with stirring for 24 hours in a liquid-to-solid ratio equal to 10,
filtering and analyses of the leachate by ICP, ion chromatography and infrared mercury analysis.

A leaching test is conducted on the gypsum silt described at item 3.1 «non-inert», which allows obtaining a reference point.

Furthermore, different maturation times (time elapsed between the addition of the binder to the silt and the leaching test which corresponds to the hydration duration of the binder) have been tested in order to check the rapidity and the evolution of the inerting over time.

3.3.2□ Assessment of the Sulfates Content Found in Leachates

The sulfates contents in the leachates have been measured by ion chromatography according to the standard NF EN ISO 10304-1.

3.3.3□ Assessment of the Amount of Chromium Found in Leachates

The chromium contents in the leachates have been measured by inductively coupled plasma (ICP) spectrometry according to the standard NF EN ISO 11885.

3.3.4□Results and Conclusions

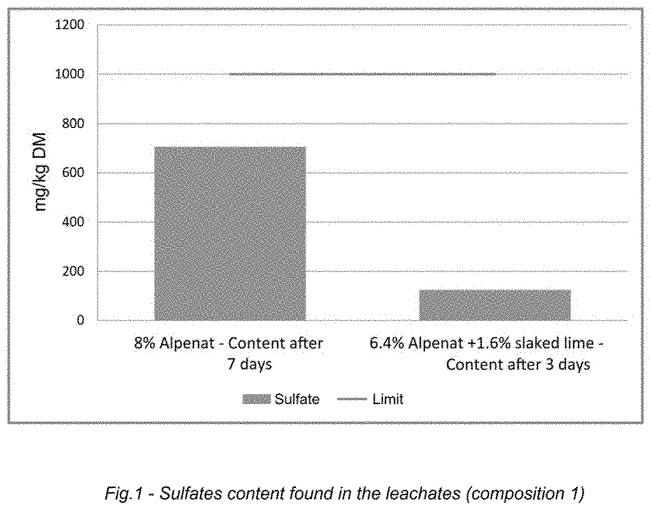

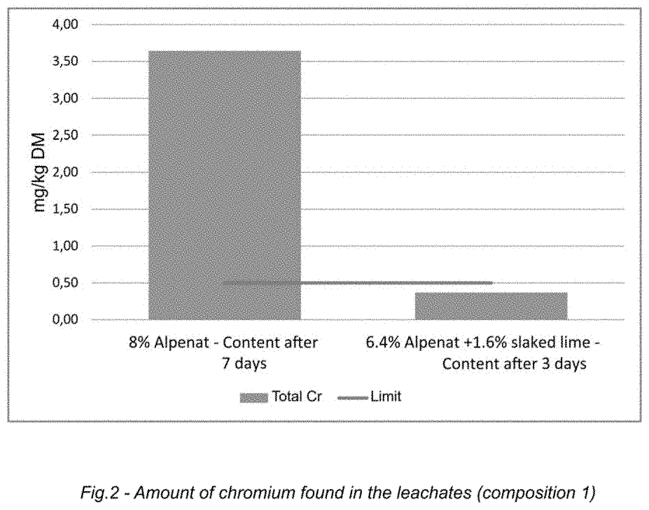

The obtained results are reported in FIGS. 1 to 6.

Note that an addition of 8% of the clinker Alpenat to the gypsum silt allows, after 7 days of maturation, capturing the sulfates (FIG. 1) satisfactorily but the leached chromium content is higher than the admissible limit for allowing classifying a waste as inert.

However, a further addition of slaked lime (within a proportion of 80% Alpenat/20% slaked lime—cf. Examples 1 and 2) allows not only obtaining a more effective and more rapid capture of the sulfates (FIG. 1) but also overcoming the problem of chromium release by lowering the leached chromium content to a value below the limit of 0.5 mg/kg of dry matter after 3 days. Furthermore, the conducted experiments prove that the leached chromium content does not increase over time.

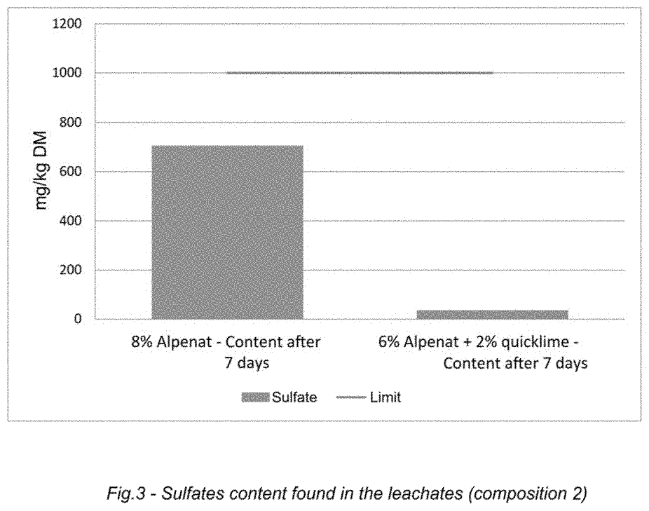

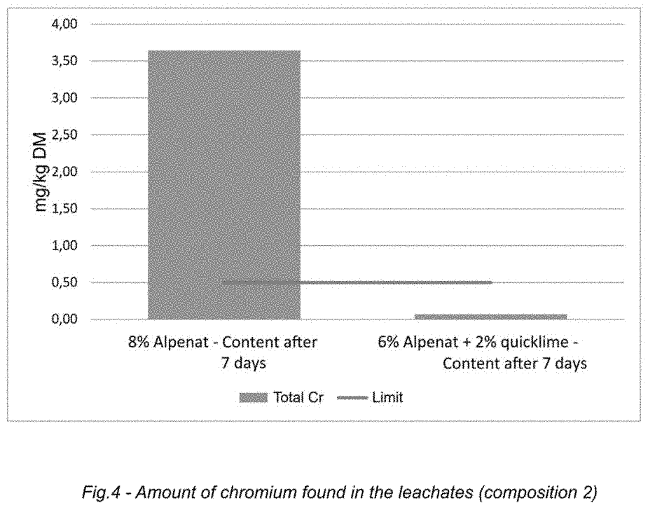

Similarly, a further addition of quicklime (within a proportion of 75% Alpenat/25% quicklime) allows, after 7 days, lowering the chromium and sulfates contents below the authorized limits (FIGS. 3 and 4).

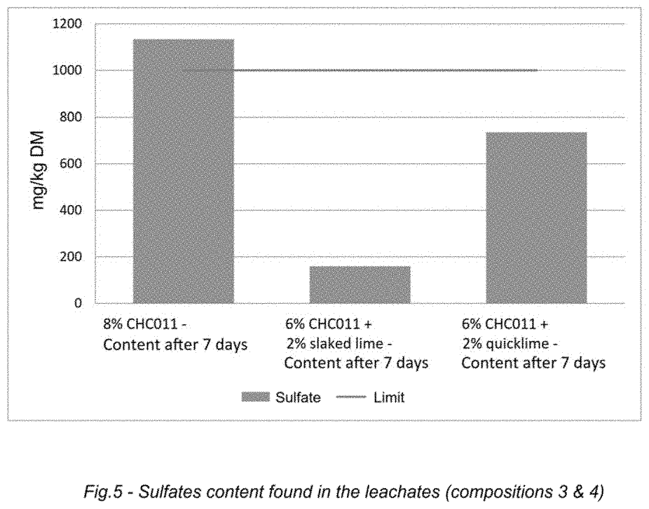

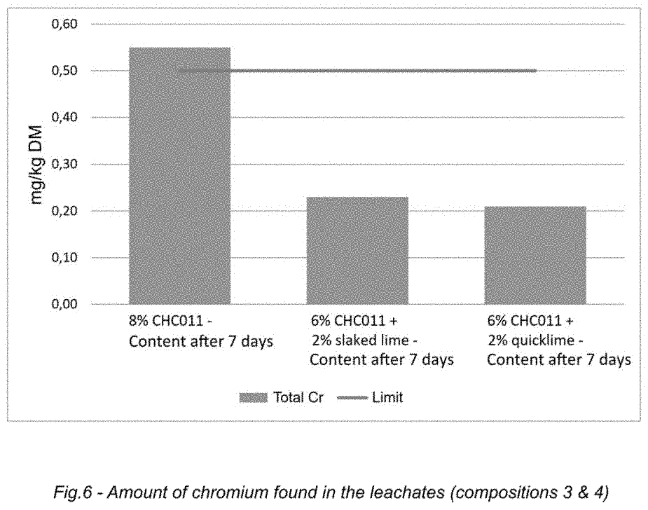

The addition of 8% of the clinker CHC011 to the gypsum silt does not allow capturing enough sulfates and chromium, after a 7-day maturation time. However, the capture of these pollutants is improved if an addition of slaked lime or quicklime (within a proportion of 75% clinker CHC011/25% quicklime or slaked lime) is performed on this clinker (FIGS. 5 and 6).

1. A method for inerting polluted soil, comprising adding to a polluted soil a composition comprising:
from 40% to 99% of a sulfoaluminous clinker comprising as a phase composition, with respect to the overall weight of the clinker:
from 5% to 80% of a calcium sulfoaluminate phase possibly iron-doped corresponding to the formula C4AxFy$z in which
x varies from 2 to 3;
y varies from 0 to 0.5; and
and z varies from 0.8 to 1.2;
from 0 to 25% of a calcium aluminoferrite phase of a composition corresponding to the general formula C₆A_{x′}F_{y′},
x′ varies from 0 to 1.5; and
y′ varies from 0.5 to 3; and
from 10% to 70% of a belite phase C₂S;
and from 1% to 60% of a lime.

2. The method according to claim 1, wherein the clinker contains from 5% to 60% of a calcium sulfoaluminate phase possibly iron-doped C₄AₓF_{y}$_{z}.

3. The method according to claim 1, wherein x varies from 2.1 to 2.9.

4. The method according to claim 1, wherein y varies from 0.05 to 0.5.

5. The method according to claim 1, wherein the clinker contains from 0 to 20% of a calcium aluminoferrite phase C₆F_{x′}F_{y′} with:
x′ varying from 0.65 to 1.3; and
y′ varying from 1.5 to 2.5.

6. The method according to claim 1, wherein the clinker contains from 20% to 70% of a belite phase C₂S.

7. The method according to claim 1, wherein the lime is quicklime.

8. The method according to claim 7, wherein the composition contains from 1% to 30% of quicklime.

9. The method according to claim 1, wherein the lime is slaked lime.

10. The method according to claim 9, wherein the composition contains from 1% to 30% of slaked lime.

11. A composition for inerting a polluted soil comprising:
from 70% to 98% of a sulfoaluminous clinker; and
and from 2% to 30% of lime
wherein the sulfoaluminous clinker comprising as a phase composition, with respect to the overall weight of the clinker:
from 5% to 80% of a calcium sulfoaluminate phase possibly iron-doped corresponding to the formula C4AxFy$z in which
x varies from 2 to 3;
y varies from 0 to 0.5; and
and z varies from 0.8 to 1.2;
from 0 to 25% of a calcium aluminoferrite phase of a composition corresponding to the general formula C₆A_{x′}F_{y′}
x′ varies from 0 to 1.5; and
y′ varies from 0.5 to 3; and
from 10% to 70% of a belite phase C₂S.

12. The composition according to claim 11, wherein it comprises from 70% to 97% of a sulfoaluminous clinker as defined in any of claims 1 to 6.

13. The composition according to claim 12, wherein it comprises from 75% to 95% of a sulfoaluminous clinker as defined in any of claims 1 to 6.

14. The composition according to claim 11, wherein it comprises from 3% to 30% of lime.

15. The composition according to claim 14, wherein it comprises from 5% to 25% of lime.

16. The composition according to claim 11, wherein the lime is slaked lime.
